(19) United States
(12) Patent Application Publication
(10) Pub. No.: US 2007/0254536 A1
(43) Pub. Date: Nov. 1, 2007

(54) ELECTRONIC UNIT

(76) Inventor: Hans-Joachim Vagt, Ulm (DE)

Correspondence Address: Striker, Striker & Stenby, 103 East Neck Road, Huntington, NY, 11743, US

(21) Appl. No.: 11/739,493

(22) Filed: Apr. 24, 2007

(30) Foreign Application Priority Data
Apr. 26, 2006 (DE) 10 2006 019 250.8

(51) Int. Cl. H01R 4/48

(52) U.S. Cl. 439/835

(57) ABSTRACT

An electronic unit, which is suitable particularly for use in an oil-filled or pressure-subjected interior of a hydraulic unit, is equipped with a printed circuit board, with a circuitry of the printed circuit board which includes conductor track portions and electronic components, the latter located in a housing portion of the printed circuit board, and having a printed circuit board extension, which in a contact portion facing away from the housing portion has electrical contact faces. The circuitry of the printed circuit board is covered in fluid-tight fashion by printed circuit board material.

### CROSS-REFERENCE TO A RELATED APPLICATION

The invention described and claimed hereinbelow is also described in German Patent Application DE 10 2006 019 250.8 filed on Apr. 26, 2006. This German Patent Application, whose subject matter is incorporated here by reference, provides the basis for a claim of priority of invention under 35 U.S.C. 119(a)-(d).

### BACKGROUND OF THE INVENTION

The invention relates to an electronic unit, in particular for use in an oil-filled or pressure-subjected interior of a hydraulic unit.

In many components of a hydraulic system, that is, the hydraulic units such as proportional valves, adjusting pumps, pressure sensors, and so forth. It is desirable to detect condition variables in the interior of the hydraulic unit and send them to electronics secured to the hydraulic unit. Such condition variables include for instance the deflection of a valve piston, or the pivot angle of an axial piston pump.

Moreover, more and more hydraulic units are being equipped with so-called “on-board electronics”, that is, triggering electronics that perform the triggering of the hydraulic unit via power amplifiers and optionally also execute closed- or open-loop control functions. A hydraulic unit with on-board electronics is distinguished by minimal configuration effort and expense in assembly and can be addressed via a standardized interface.

In the course of miniaturization, it would be desirable if at all possible to located all the electronics inside the hydraulic unit. However, this requires a complicatedly sealed-off housing for the electronics, particularly in the region of the leadthrough of supply lines through the housing wall. Moreover, housings that are suitably pressure-proof or resistant to pressure media are relatively large and can therefore not be used in the interior of a hydraulic unit.

### SUMMARY OF THE INVENTION

It is the object of the present invention to provide an improved electronic unit, which is especially well suited for use in an oil-filled or pressure-subjected interior of a hydraulic unit.

The electronic unit of the invention is equipped with a printed circuit board, with a circuitry of the printed circuit board which includes conductor track portions and electronic components, the latter located in a housing portion of the printed circuit board, and having a printed circuit board extension, which in a contact portion facing away from the housing portion has electrical contact faces. The circuitry of the printed circuit board is covered in fluid-tight fashion by printed circuit board material.

The special feature of the invention is thus that from printed circuit board material, a liquid-proof housing with a printed circuit board extension protruding from it for the electrical connection is formed. The housing formed by the printed circuit board and its covering is stable and pressure-proof. It can readily be machined mechanically, for instance in order to make fastening bores. The use of printed circuit board material makes high chemical resistance possible, especially to mineral oils of the kind conventionally used as pressure fluid. The printed circuit board extension, as a component of the printed circuit board, merges seamlessly with the housing portion, without the covering of the circuitry being interrupted by a transition from one material to another. As a result, gaps that can occur at transitions of material, for instance between a metal conductor track and synthetic resin, are avoided, and an extremely reliable sealing of the electronic unit is thus achieved.

The electronic unit of the invention protects the components disposed in it especially well against an alternating pressure stress. The printed circuit board extension, with an only slight material thickness and/or given a suitable choice of the printed circuit board material, is flexible and can be extended comparably to a cord out of the interior of the hydraulic unit. According to the present invention, compact electronic units can thus be achieved, whose circuitry in the interior of the hydraulic unit is completely covered with printed circuit board material, and which have an opening in the covering only in the outer region of the hydraulic unit—for instance, in the contact portion. The electronic unit of the invention can be produced easily within existing printed circuit board production and assembly processes.

In principle, for designing the unit, many structural variants that are conventional in printed circuit board technology are available. This includes for instance the provision of inlay bodies of metal, glass fibers, synthetic fibers, or ceramic in order to increase the pressure resistance, stability, and bending resistance and/or to improve heat dissipation. With the omission of a separate housing and seals, the present invention permits economical production of the electronic unit. The printed circuit board can be dipped entirely in hydraulic pressure fluid and thus makes the efficient cooling of the electronic circuitry possible.

Preferably, the printed circuit board has a plurality of printed circuit board layers, placed one above the other. The production, including the assembly and contacting of the electronic components, can be done in a similar way to the production of a standard printed circuit board. After that, the printed circuit board is supplemented with a cover layer of printed circuit board material, forming a housing. In this way, even printed circuit boards that have electronic components on multiple layers can be produced. The cover layer is applied in a concluding work step. The printed circuit board layers applied on top of one another make a tight, stable chemical bond among all the materials and components used possible.

Especially simple production is achieved if the printed circuit board layers are glued to one another. In this way, fully assembled printed circuit board layers can be prefabricated and glued together in a concluding work step to make a multilayer printed circuit board that at the time acts as the housing of the electronic unit. This simplifies the production and assembly of the printed circuit board, while utilizing existing production processes. If electronic components of low structural height—such as SMD elements—are used, then they can be embedded in the adhesive layer.

In an especially preferred feature of the present invention, the printed circuit board extension is formed by means of two printed circuit board layers, located one above the other, of the printed circuit board. Here one of the printed circuit board layers forms a substrate layer for the printed circuit board extension. Conductor tracks are disposed on it. The second printed circuit board layer forms a cover layer of the printed circuit board extension. This makes it possible in a simple way to connect the printed circuit board extension seamlessly to the housing portion of the printed circuit board. Embodying the printed circuit board extension of only two printed circuit board layers makes it possible to assure an especially low profile and good bendability of the printed circuit board extension.

Preferably, printed circuit board layers in the printed circuit board extension include a polyester film, in particular a polyimide film. This is a time-tested material for flexible printed circuit boards. Hence especially good bendability is attained, along with good stability of the printed circuit board extension.

In a further preferred feature, inlays, in particular a glass fiber reinforcement, located in the printed circuit board have a covering coating on an outside of the electronic unit. If a glass fiber reinforcement is used, a mechanically heavy-duty printed circuit board is obtained. The capillary effect, because of which pressure fluid could penetrate along the glass fibers into the printed circuit board, is effectively suppressed. In the case of inlays of metal or ceramic as well, which end flush with the outside, the cover coating prevents liquid from penetrating along material transition gaps. Epoxy resin, for instance, may be used as the coating material.

Preferably, the circuitry of the printed circuit board includes a contactless sensor, in particular a Hall sensor, a capacitive proximity sensor, an optical sensor, or an inductive sensor. By means of such sensors, conditions in the interior of the hydraulic unit can be detected without there being moving components or electrical contacts on the outside of the housing portion of the electronic unit. As a result, sealing problems are precluded from the very outset. By means of a Hall sensor, switching positions of a valve can for instance be attained. If the printed circuit board material is transparent, then an optical sensor located in the interior of the printed circuit board can equally well be employed. A capacitive proximity sensor, an optical sensor, or an inductive sensor can be provided, for instance as a component of a distance measuring system, in a valve or a cylinder.

If middle printed circuit board layers have recesses in which electronic components are received, then even relatively large components can easily be integrated into the electronic unit. Once the components have been inserted, the recesses can be filled with a suitable potting composition, to improve the stability and the thermal connection of the components to the printed circuit board.

In a further preferred embodiment of the present invention, the printed circuit board extension, in a leadthrough portion, has a thickened portion formed of printed circuit board material. As a result, better or simpler sealing off of a leadthrough of the printed circuit board extension on a housing of a hydraulic unit can be attained. The thickened portion enhances the dimensional stability of the printed circuit board extension in the region of the leadthrough portion. As a result, the leadthrough portion of the printed circuit board extension, given a low pressure load, can itself act as a sealing element. A leadthrough portion of this kind can furthermore be braced by a bearing face oriented perpendicular to the longitudinal direction of the printed circuit board extension. The surface of the thickened leadthrough portion can furthermore be structured or roughened, to improve the adhesion of a sealing element resting on it or integrally molded onto it. It will be noted that a thickened portion of a printed circuit board extension or of a conductor foil tail in the region of a sealed-off leadthrough is already considered advantageous on its own. The characteristics of claim 1 are considered optimal with a view to the embodiment of the seal.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a side view of an electronic unit, which is secured in the interior of a hydraulic unit, in fragmentary section in accordance with the present invention; and

FIG. 2 shows the electronic unit of FIG. 1 in accordance with the present invention, in a top view.

### DESCRIPTION OF THE PREFERRED EMBODIMENT

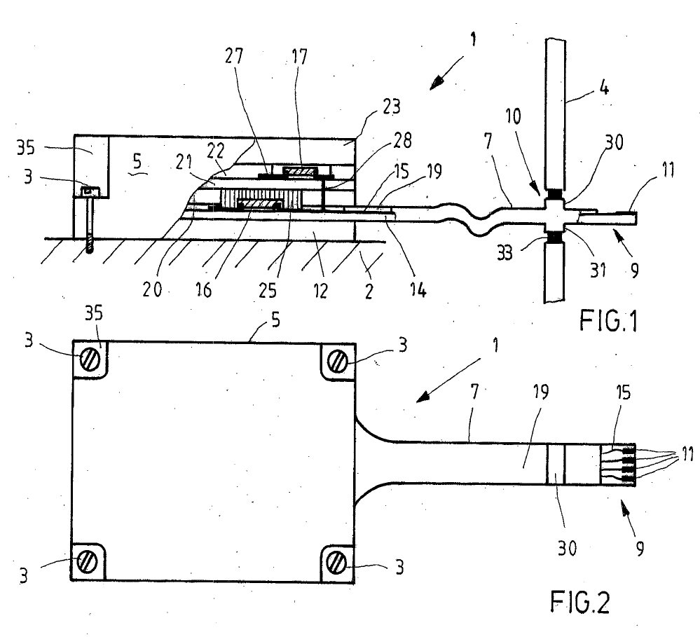

In FIG. 1 and FIG. 2, the electronic unit 1 is secured in the interior of a hydraulic unit on a suitable base 2 by means of screws 3. The electronic unit 1 has a housing portion 5 as well as a printed circuit board extension 7. The printed circuit board extension 7 is extended through a housing wall 4 of the hydraulic unit to the outside. There, it has a contact portion 9 on which electrical contact faces 11 are located.

In the region of the leadthrough 10, a thickened portion 30 and 31 of printed circuit board material is formed on the printed circuit board extension 7. This thickened portion is applied at the top and bottom as an additional layer onto the printed circuit board material that forms the printed circuit board extension 7. The thickened portion 30 and 31 assures high dimensional stability of the printed circuit board extension 7 in the region of the leadthrough 10. The thickened portion can serve by itself as a sealing element, if the pressure load is low.

The surface of the thickened portion 30 and 31 can be structured or roughened, in order to assure an intimate contact with a sealing element 33 resting on it or integrally molded to it. This would not be possible with conventional conductor foil tails, because with them the material is so thin. The printed circuit board extension 7 can additionally be braced on the thickened portion 30 and 31 by a bearing face (not shown), formed on the housing wall 4 perpendicular to the longitudinal direction of the printed circuit board extension 7. As a result, among other things, a tension relief can be implemented that is effective against externally exerted tensile forces and pressure forces exerted from inside the housing wall 4.

The housing portion 5 is seated with a substrate layer 12 of printed circuit board material on the base 2. A further printed circuit board layer 14 is applied to the substrate layer 12. The printed circuit board layer 14 protrudes past the substrate layer 12 on the right-hand side of the housing portion 5 and forms a lower layer of the printed circuit board extension 7. Electrical conductor tracks 15 are formed on the printed circuit board layer 14. They connect the contact faces 11 to electronic components 16 and 17 in the interior of the housing portion 5.

A cover layer 19 of printed circuit board material is applied to the printed circuit board layer 14 and to the conductor tracks 15 located on it. The cover layer 19 covers the printed circuit board layer 14, particularly in the region of the printed circuit board extension 7 located in the interior of the hydraulic unit. In the outer region, on the far side of the leadthrough 10, the printed circuit board layer 14 protrudes underneath the cover layer 19, so that the contact faces 11 on the contact portion 9 are accessible.

Further printed circuit board layers 20, 21, 22 and 23 are applied to the cover layer 19. The printed circuit board layer 20 serves as a spacer and, like the printed circuit board layer 19, has a recess in which the component 16 is disposed. The printed circuit board layer 21 closes the hollow space that is formed by the recesses. The hollow space is filled with a potting composition 25. As a result, the stability of the structure can be increased, and the thermal connection of the component 16 to the surrounding printed circuit board layers can be improved.

The printed circuit board layer 21 has further circuitry comprising conductor tracks 27 and the component 17. An electrical conductor 28, extending transversely to the layer structure, connects conductor tracks 15 on the layer 14 with conductor tracks on the layer 21. The printed circuit board layer 22 has a recess for receiving the component 17. The hollow space thus formed is covered by the topmost printed circuit board layer 23.

The printed circuit board layers 12 and 23 carry no circuitry but instead serve, in the exemplary embodiment shown, as a covering as a substrate layer. The printed circuit board layers 12 and 23 may, however, certainly also carry circuitry, if it is located only on the inward-oriented surface. The circuitry also has a certain spacing from the lateral edge of the housing portion 5, so that the housing portion 5, viewed from the outside, has a tight surface that is also homogeneous, as long as it has only printed circuit board material but neither circuitry elements nor conductor tracks.

The printed circuit board material may be based on epoxy resin. This allows individual printed circuit board layers 12, 14, 19, 20 through 23 to be successively applied to one another and cured. In intermediate steps, the various conductor tracks 15 and 27 may be applied and the assembly can be done. If a glass fiber material is used for reinforcement, the ends of the glass fibers located in the outer face are covered by a further layer, so that no pressure fluid will penetrate along the glass fibers into the electronic unit 1. Once again, epoxy resin may be used for this.

Instead of successively applying the printed circuit board layers to one another and curing them, individual printed circuit board layers may also be prefabricated, optionally including their circuitry, and glued to one another in a concluding work step. Once again, epoxy resin material may be used for this. If the components 16 and 17 have only a slight structural height, then they can be embedded in the adhesive layer. SMD components are especially suitable for this purpose.

If epoxy resin is used as the printed circuit board material, then with only a slight material thickness the printed circuit board extension 7 is sufficiently flexible to allow it to be laid as cable is laid. Instead of being made from epoxy resin, the printed circuit board layers may also be made of some other printed circuit board material, such as polyimide film. Particularly for the printed circuit board layers 14 and 19 that merge with the printed circuit board extension 7, such a material is advantageous, but the compatibility of the materials with one another with regard to the adhesive bonds to the adjacent printed circuit board layers 12 and 20 must be assured. As a result, an even more- flexible printed circuit board extension 7 is obtained that can be laid like a cable and at the same time is tear-resistant.

It is also entirely possible for the printed circuit board layers 12 and 20 through 23 that do not extend past the housing portion 5 to be produced from an epoxy resin material, and for the printed circuit board layers 14 and 19 that form the printed circuit board extension 7 to be made from polyimide foil, and to glue the layers of different printed circuit board material to one another. The printed circuit board extension 7 may also have more than two printed circuit board layers, if greater strength and bending resistance are desired. Moreover, part of the circuitry may be located in the printed circuit board extension 7, and the housing portion 5 can be correspondingly smaller as a consequence.

Since the printed circuit board layers, with the exception of any hollow spaces for components, are joined or glued together entirely chemically, the electronic unit 1, at least in regions without circuitry, can be mechanically machined afterward without impairing the tightness. Bores, indentations 35 for receiving heads of screws, and so forth can for instance be made. In the production of individual printed circuit board layers, however, these layers may also be stamped out with a suitable shape. In this way, the hollow spaces for receiving the components 16 and 17 are also simple to make.

It will be understood that each of the elements described above, or two or more together, may also find a useful application in other types of constructions differing from the type described above.

While the invention has been illustrated and described as embodied in an electronic unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An electronic unit, comprising a printed circuit board having a housing portion, a circuitry which includes conductor track portions and electronic components located in said housing portion, and an extension having electrical contact faces on a contact portion facing away from said housing portion, wherein said circuitry of said printed circuit board is covered in a fluid-tight fashion by a material of said printed circuit board.

2. An electronic unit as defined in claim 1, wherein said printed circuit board has a plurality of printed circuit board layers placed one above the other.

3. An electronic unit as defined in claim 2, wherein said printed circuit board layers are glued to one another.

4. An electronic unit as defined in claim 2, wherein said extension of said printed circuit board is formed by two of said printed circuit board layers of said printed circuit board, located one above the other.

5. An electronic unit as defined in claim 2, wherein said layers of said printed circuit board in said extension include a polyester film.

6. An electronic unit as defined in claim 5, wherein said polyester film is configured as a polyamide film.

7. An electronic unit as defined in claim 1; and further comprising inlays located in said printed circuit board and having a covering coating on an outside of the electronic unit.

8. An electronic unit as defined in claim 1, wherein said circuitry of said printed circuit board includes a sensor selected from the group consisting of a contactless sensor, a capacitive proximity sensor, an optical sensor, and an inductive sensor.

9. An electronic unit as defined in claim 8, wherein said contactless sensor is configured as a Hall sensor.

10. An electronic unit as defined in claim 2, wherein said printed circuit board layers have middle printed circuit board layers provided with recesses in which said electronic components are received.

11. An electronic unit as defined in claim 1, wherein said extension of said printed circuit board in a leadthrough portion has a thickened portion formed of a material of said printed circuit board.
